(19) United States
(12) Patent Application Publication
(10) Pub. No.: US 2021/0140528 A1
(43) Pub. Date: May 13, 2021

(54) ROTATING DEVICE CAPABLE OF INSTANT ACCELERATION OF HIGH TORQUE

(71) Applicant: XENARTS,INC., Daejeon (KR)

(72) Inventors: Wan-Pyo LEE, Daejeon (KR); Woo-Yong PARK, Daejeon (KR); Chan-Soon LIM, Daejeon (KR)

(73) Assignee: XENARTS,INC., Daejeon (KR)

(21) Appl. No.: 16/620,713

(22) PCT Filed: Jun. 7, 2018
(86) PCT No.: PCT/KR2018/006473

§ 371 Date: Dec. 9, 2019

(30) Foreign Application Priority Data
Jun. 9, 2017 (KR) 10-2017-0072772

(51) Int. Cl. F16H 49/00; F16H 3/72; F16H 48/12

(52) U.S. Cl. CPC F16H 49/001; F16H 55/0833; F16H 48/12; F16H 3/727

(57) ABSTRACT

Disclosed is a rotating device including: a first gear part having a first gear; a second gear part coupled to the first gear and having a second gear that rotates relative to the first gear; a third gear part coupled to the second gear and having a third gear that rotates relative to the second gear; and first and second driving units for respectively providing rotational driving forces to first and second input gear parts which are two gear parts of the first to third gear parts to determine a rotational output of an output gear part which is the remaining gear part. At least one of the first and second driving units changes the rotational speed of at least one of the first and second input gear parts to change the rotational speed of the output gear part.

### CROSS-REFERENCE TO PRIOR APPLICATIONS

This application is a National Stage Patent Application of PCT International Patent Application No. PCT/KR2018/006473 (filed on Jun. 7, 2018) under 35 U.S.C. § 371, which claims priority to Korean Patent Application No. 10-2017-0072772 (filed on Jun. 9, 2017), which are all hereby incorporated by reference in their entirety.

### BACKGROUND

The present invention relates to a rotating device that is efficient in switching between forward and reverse rotation and is capable of realizing a strong torque output and instant acceleration.

Research is in progress to precisely control a prime mover device, such as an actuator, which is used to operate or control a system. In addition, a low cost and uncomplicated device that requires a strong torque, a device efficient for forward and reverse rotation, and a rotating device with a large instantaneous acceleration are required.

### SUMMARY

An objective of the present invention is to provide a device for providing a rotational force in a steady state, which maintains a strong torque force steadily in a stationary state or in a motion state in which the device rotates at a constant velocity.

In addition, the present invention provides a rotating device capable of stably changing an output rotation direction from clockwise to counterclockwise, or vice versa.

Further, the present invention provides a device that stably and rapidly changes an output rotational force.

A rotating device capable of instant acceleration according to one embodiment of the present invention includes a first gear part including a first gear; a second gear part including a second gear that is connected to the first gear to rotate relative to the first gear; a third gear part including a third gear that is connected to the second gear to rotate relative to the second gear; and first and second driving units for respectively providing a rotational driving force to first and second input gear parts, which are two gear parts of the first to third gear parts, to determine an output power of an output gear part that is a remaining gear part, wherein at least one of the first and second driving units changes at least one of an output rotational velocity and an output torque, which are the output power, by changing a rotational speed of at least one of the first and second input gear parts, a rotation direction of the first input gear part before and after the change of the output power may be identical to an initial rotation direction of the first input gear part, and a rotation direction of the second input gear part before and after the change of the output power may be identical to an initial rotation direction of the second input gear part.

When at least one of the output rotational velocity and the output torque is not zero, the rotational speeds of the first and second input gear parts may exceed zero.

The first and second driving units may be driven such that the output rotational velocity is zero and the output torque exceeds zero.

The change of the output power may be any one of the following cases, including where the output rotational velocity is constant and the output torque is changed, where the output rotational velocity is changed and the output torque is constant, and where the output rotational velocity and the output torque are all changed.

The first and second driving units may be driven such that the output rotational velocity is changed from a first direction to a second direction.

At least one of the first and second driving units may abruptly stop at least one of the first and second input gear parts to rapidly change a rotational velocity of the output gear part in response to the abrupt stop.

At least one of the first and second input gear parts may further include a flywheel that maintains a rotational inertia.

Any one of the two gear parts may have a greater rotational inertia than the other gear part and a rotational velocity of the remaining gear part may be rapidly changed in response to the abrupt stop of the rotation by abruptly stopping rotation of the gear part of the two gear parts that has a smaller rotational inertia.

The rotating device may further include a planetary gear train including a planetary gear part that is connected to a ring gear, a sun gear, and a carrier, which are arranged on the same shaft, and connects the ring gear and the sun gear, wherein the first gear part includes the ring gear, the second gear part includes the carrier, and the third gear part includes the sun gear.

The second gear part may include a differential case which is rotatable and accommodates a driving gear and the first and third gear parts may include first and second driven gears, respectively, that are engaged to the driving gear in a bevel gear manner.

The first gear part may be provided with an elliptical wave cam, the second gear part may be provided with a flex spine that is mounted on an outside of the wave cam, has a plurality of teeth on an outer circumferential surface thereof, and is elastically deformed by the wave cam, and the third gear part may be provided with a circular spline that accommodates the flex spline and has a tooth shape formed in an interior thereof to which the flex spline is engaged.

A method of controlling a rotating device according to the present invention is to control a rotating device capable of instant acceleration which includes a first gear part including a first gear, a second gear part including a second gear that is connected to the first gear to rotate relative to the first gear, a third gear part including a third gear that is connected to the second gear to rotate relative to the second gear, and first and second driving units for respectively providing a rotational driving force to first and second input gear parts, which are two gear parts of the first to third gear parts, to determine an output power of an output gear part that is a remaining gear part, and the method includes changing, by at least one of the first and second driving units, at least one of an output rotational velocity and an output torque, which are the output power, by changing a rotational speed of at least one of the first and second input gear parts, wherein a rotation direction of the first input gear part before and after the change of the output power may be identical to an initial rotation direction of the first input gear part and a rotation direction of the second input gear part before and after the change of the output power may be identical to an initial rotation direction of the second input gear part.

Additional features of the invention will be set forth in the description which follows, and in part will be apparent from the description, or may be learned by practice of the invention.

A rotating device according to the present invention allows a driving device of an input part to continuously rotate and is thereby able to have a high output torque in a stationary state or in a rotation state.

The rotating device according to the present invention may have high acceleration performance, power transmission efficiency, and energy efficiency, and may generate low vibration.

### BRIEF DESCRIPTION OF THE DRAWINGS

FIG. 1 is a block diagram illustrating a structure of a rotating device according to one embodiment of the present invention;

FIG. 2 is a diagram illustrating one embodiment of the rotating device of FIG. 1;

FIGS. 3 and 4 are cross-sectional views of a gear train according to each embodiment of the rotating device illustrated in FIG. 2;

FIG. 5 is a diagram illustrating another embodiment of the rotating device;

FIG. 6 is a diagram illustrating still another embodiment of the rotating device; and

FIG. 7 is a flowchart illustrating a method of controlling the rotating device according to one embodiment.

### DETAILED DESCRIPTION

Hereinafter, the present invention will be described in more detail with reference to the accompanying drawings.

It will be understood that, although the terms first, second, etc. may be used herein to describe various elements, these elements should not be limited by these terms. These terms are only used to distinguish one element from another. For example, a first unit could be termed a second unit, and, similarly, a second unit could be termed a first unit without departing from the teachings of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

When an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. In addition, it is understood that when a first element is connected to or accesses a second element in a network, the first element and the second element can transmit and receive data therebetween.

In the following description, usage of suffixes such as “module” or “unit” used for referring to elements is given merely to facilitate explanation of the present invention, without having any significant meaning by itself. Thus, the “module” and “unit” may be used together.

When the elements described herein are implemented in the actual applications, two or more elements may be combined into a single element, or one element may be subdivided into two or more elements, as needed. Throughout the drawings and the detailed description, unless otherwise described, the same drawing reference numerals are understood to refer to the same elements, features, and structures.

FIG. 1 is a block diagram illustrating a structure of a rotating device according to one embodiment of the present invention.

Referring to FIG. 1, a rotating device according to the present invention may include a first gear part to a third gear part G1 to G3 and at least two of a first drive feeding unit to a third drive feeding unit D1 to D3.

The first to third gear parts G1 to G3 may respectively include first to third rotation shafts a1 to a3 that operate as an input or output shaft. At least one of the first to third gear parts G1 to G3 may include a gear (one of g1 to g3) fastened or connected to the rotation shaft (one of a1 to a3). For example, the first rotation shaft a1 may be provided with a first gear g1, and the first gear g1 may be directly fastened, geared, or connected through a connecting bar, such as a carrier, to have the same axis as the first rotation shaft a1.

The first to third gear parts G1 to G3 may respectively include the first to third gears g1 to g3. The second gear g2 may be connected to the first gear g1 to rotate relative to the first gear g1. The second gear g2 may be connected to the third gear g3 to rotate relative to the third gear g3. The rotation of each gear may be fundamentally based on self-rotation and may be additionally revolution. A rotational velocity of one of the first to third rotation shafts a1 to a3 may be dependent on the rotational velocities of the remaining two of the first to third rotation shafts a1 to a3 by the connection of the first to third gears g1 to g3.

The first to third drive feeding units D1 to D3 may be connected to the first to third rotation shafts a1 to a3, respectively. Each of the drive feeding units may supply a driving force to rotate the connected rotation shaft and may include a brake to reduce or stop the rotation of the rotation shaft. Each of the drive feeding units may include a flywheel to increase rotational inertia. The flywheel may be fastened to the rotation shaft of the gear part independently of the drive feeding unit.

The components of the rotating device may be divided into an input art and an output part.

The input part may include two drive feeding units (hereinafter referred to as “first and second driving units”) among the first to third drive feeding units D1 to D3. The input part may further include gear parts (hereinafter referred to as “first and second input gear parts”) respectively connected to the first and second driving units among the first to third gear parts G1 to G3. The first and second driving units may supply a rotational driving force to the first and second input gear parts.

The output part may include a gear part (hereinafter referred to as an “output gear part”) that is not the input part among the first to third gear parts G1 to G3. An output shaft of the output part may be a rotation shaft of the output gear part.

The output part may further include a drive feeding unit (hereinafter referred to as an “output driving unit”) that is not the input part among the first to third drive feeding units D1 to D3. The output driving unit may additionally supply a driving force (rotational force) to the output shaft of the output driving unit.

The rotating device according to the present invention may further include a control unit (not shown). The control unit may generally control the operations of the first and second driving units to control the overall operation of the rotating device according to the present invention. The control unit may control at least one of the first and second driving units to control a rotational speed of at least one of the first and second input gear parts, and finally determine an output power of the output gear part.

The output power of the output shaft refers to a rotational velocity (hereinafter referred to as an “output rotational velocity”) of the output shaft and a torque (hereinafter referred to as an “output torque”).

The first and second driving units may respectively supply a rotational driving force to the first and second input gear parts to determine an output power of the output gear part. The output power to be determined may be an output rotational velocity and an output torque, or one of the output rotational velocity and the output torque. Preferably, the output rotational velocity and the output torque are determined at the time of initial driving.

When the output gear part rotates at a specific rotational velocity, the first and second input gear parts may be preferably driven such that the respective rotation directions thereof are the same as the initial rotation directions thereof. This means that the rotation directions of the first and second driving units are not reversed. For example, in a case where the driving unit is a motor, forward and reverse rotation of the motor is not required and hence a problem due to the forward and reverse rotation does not occur. The first and second driving units only need to continuously rotate in one direction, and hence are not affected by mechanical or electrical problems due to reversal of rotation direction. This means that various motors can be used for the first and second driving units. Because the rotation directions of the first and second driving units are not reversed, mechanical stress, vibration, failure rate, and the like of the motor or the like due to the reversal of the rotation direction may be reduced, and surge voltage or the like caused by a change in voltage of an energy source supplied to the motor may be prevented.

When at least one of the output rotational velocity and the output torque is not zero, the rotational speeds of the first and second input gear parts preferably exceed zero. Since the output power can be altered by changing the rotational speeds of the motors (the first and second driving units) in one direction, control may be facilitated. The control unit may vary the rotational speeds of the first and second input gear parts to have various output torques at a specific output rotational velocity. For example, the control unit may change the output torque while controlling the output rotational velocity to be 0. In this case, preferably the output torque may not be zero.

At least one of the first and second driving units may change the rotation output of the output gear part by changing a rotational speed of a connected input gear part. The change of the rotation output may be any one of the cases, including where the output rotational velocity is constant and the output torque is changed, where the output rotational velocity is changed and the output torque is constant, and where the output rotational velocity and the output torque are all changed.

When the rotation output is changed, the rotation direction of each of the first and second input gear parts is preferably the same as an initial rotation direction. This is because the motor can rotate in one direction. Also, the rotational speeds of the first and second input gear parts preferably exceed zero. This is because immediate output change becomes possible.

The output rotational velocity during the rotation output may be changed from a first direction to a second direction. That is, without the direction reversal of the first and second input gear parts, the output rotational velocity may be changed from forward rotation to reverse rotation by only change of each of the rotational speeds.

At least one of the first and second driving units may abruptly stop the rotation of the connected input gear part and rapidly change the rotational velocity of the output gear part in response to the abrupt stop of the input gear part.

Preferably, the first input gear part of the input part has a greater rotational inertia than the second input gear part. It is preferable that the difference is a ratio of 2 to 10000. The high rotational inertia of the first input gear part may be achieved by the aforementioned flywheel or the like. In this case, when the rotational velocity of the output part is rapidly changed by the abrupt stop of the input part mentioned above, it is preferable to abruptly stop the rotation of the second input gear part that has a smaller rotational inertia. Moreover, the first input gear part that has a greater rotational inertia preferably maintains a constant velocity. This is because when the output part performs rapid acceleration, it is possible to maintain stable and consistent rapid acceleration performance of the output part if the first input gear part having a greater rotational inertia is rotated at a specific velocity.

FIG. 2 is a diagram illustrating one embodiment of the rotating device of FIG. 1, FIGS. 3 and 4 are cross-sectional views of a gear train according to each embodiment of the rotating device illustrated in FIG. 2, and FIG. 7 is a flowchart illustrating a method of controlling the rotating device according to one embodiment.

Referring to FIGS. 2 and 3, the rotating device according to the present invention may include a plurality of gear parts 110, 120, 130, and 140 and first and second driving units 152 and 162. A speed reduction device according to the present embodiment may be a planetary gear device.

The plurality of gear parts may include a ring gear part 110, a carrier part 120, and a sun gear part 130. Each of the plurality of gear parts may correspond to each of the first to third gear parts G1 to G3 shown in FIG. 1. That is, the first gear part G1, the second gear part G2, and the third gear part G3 may correspond to the ring gear part 110, the carrier part 120, and the sun gear part 130, respectively.

The ring gear part 110 may include a ring gear 112 and a ring gear shaft 115. The ring gear 112 and the ring gear shaft 115 may correspond to the first gear g1 and the first rotation shaft a1 of FIG. 1, respectively.

The sun gear part 130 may include a sun gear 132 and a sun gear shaft 135. The sun gear 132 and the sun gear shaft 135 may correspond to the third gear g3 and the third rotation shaft a3 of FIG. 1, respectively.

The carrier part 120 may include a carrier 122 and a carrier shaft 125. The carrier part 120 may further include a planetary gear part 140. The planetary gear part 140 may include at least one planetary gear 142 and 144. The carrier shaft 125 and the planetary gears 142 and 144 may correspond to the second rotation shaft a2 and the second gear g2, respectively.

The ring gear 112 and the sun gear 132 may be arranged on the same shaft. The ring gear 112 and the sun gear 132 may be connected to each other by the planetary gear part 140. The planetary gear part 140 may be connected by the carrier 122 and constituted by at least one planetary gear. While in the present embodiment, the planetary gear part 140 is embodied by the first and second planetary gears 142 and 144, the planetary gear part 140 is not limited thereto, and may be embodied by one or three or more planetary gears. The ring gear 112, the sun gear 132, the planetary gear part 140, and the carrier 122 may form a planetary gear train. FIG. 3 is an example of an arrangement state of each gear of the planetary gear train, and the present invention is not limited thereto. For example, as shown in FIG. 3, the carrier shaft 125 may be formed to be hollow so that the sun gear shaft 135 is exposed to the outside, or as shown in FIG. 4, the ring gear shaft 115 may be formed to be hollow so that the sun gear shaft 135 may protrude to the outside through a hollow portion of the ring gear shaft. In the case of FIG. 4, the carrier shaft 125 may be prepared in a shape other than hollow.

The first and second driving units 152 and 162 may supply a driving force to any two of the ring gear part 110, the sun gear part 130, and the carrier part 120. Thus, two of the plurality of gear parts serve as input terminals and the remaining one gear part serves as an output terminal. The first and second driving units 152 and 162 may be any devices that supply a rotational force, and they are illustrated as motors in the present embodiment and are not limited thereto. The first and second driving units 152 and 162 may provide the rotational force directly to the ring gear 112, the sun gear 132, and the carrier 122 of a unit that is to receive the driving force among the ring gear part 110, the sun gear part 130, and the carrier part 120, provide the rotational force directly to each shaft 115, 135, and 125 of the gears of the input unit, or provide the rotational force using a gear, a belt, a chain, or the like.

The first and second driving units 152 and 162 may further include a brake (not shown). The brake may brake the rotation of the input unit. The brake may use a general brake structure. The brake may include air resistance, regenerative brake, an emergency stop device of an alternating current (AC) motor, and the like. The rotating device according to the present invention may further include a control unit 100. The control unit 100 may generally control operations of the first and second driving units 152 and 162 to control an overall operation of the rotating device according to the present invention.

Referring to FIG. 3, in the present embodiment, the first and second driving units 152 and 162 are illustrated as providing a driving force to the ring gear part 110 and the sun gear part 130, respectively. However, the embodiment is not limited thereto and the driving force may be provided to various combinations of two units of the ring gear part 110, the sun gear part 130, and the carrier part 120. The first and second driving units 152 and 162 may provide the driving force to the ring gear part 110 and the sun gear part 130, respectively, to determine an output power of the carrier part 120 which is an output part. That output power may consist of an output rotational velocity and an output torque.

The control unit 100 may control the driving force of the first and second driving units 152 and 162 to determine the output power of the carrier part 120. Hereinafter, driving force control of the first and second driving units 152 and 162 of the control unit 100 will be interchangeably used with driving force provision of the first and second driving units 152 and 162.

Referring to FIG. 7, the control unit 100 may receive a first power command P1 from a user through a communication unit (not shown) or various interfaces (S410). The control unit 100 may set a rotational speed Vi1 of the ring gear part 110 and a rotational speed vi2 of the sun gear part 130 such that the output power of the carrier part 120 corresponds to the received first power command P1 (S420).

The output rotational velocity in the output power of the carrier part 120 is preferably identical to a first rotation velocity command Vo1 of the first power command P1. This is because the most important part of the control of the rotating device is the rotational velocity. The output torque in the output power of the carrier part 120 may be determined within a boundary having a margin with a first torque command τ1 of the first power command P1. That is, the actual output rotational velocity of the carrier part 120 may be controlled to be the same as the control command and the output torque may be controlled to have a predetermined difference from the control command. The output torque of the carrier part may be slightly different from the first torque command τ1 of the control command, i.e., the first power command P1, and the actual output torque is preferably greater than the first torque command τ1 in the control command. Such control may be applied to an output power change stage, which will be described below.

The control unit 100 may variously determine the rotational speeds Vi1 and Vi2 of the ring gear part 110 and the sun gear part 130. For example, the control unit 100 may determine to change the rotational speeds of all of the ring gear part 110 and the sun gear part 130, or to change one of the two rotational speeds. Alternatively, the control unit 100 may determine to raise the rotational speed of one of the ring gear part 110 and the sun gear part 130 and lower the rotational speed of the other part. Alternatively, the rotational speeds of all of the ring gear part 110 and the sun gear part 130 may be determined to be raised or lowered.

The control unit 100 may transmit a control signal to the first and second driving units 152 and 162 such that the ring gear part 110 and the sun gear part 130 rotate respectively corresponding to the determined rotational speeds Vi1 and Vi2.

The control unit 100 may control the rotation directions of the ring gear part 110 and the sun gear part 130 to be the same as the initial rotation directions.

When at least one of the output rotational velocity and output torque of the carrier part 120 is not zero, the control unit 100 preferably controls the rotational speed of each of the ring gear part 110 and the sun gear part 130 to exceed zero.

The control unit 100 may control such that the output rotational velocity of the carrier part 120 is zero and the output torque exceeds zero.

Referring to FIGS. 2 and 3, the control unit 100 may change at least one of the output rotational velocity and output torque of the carrier part 120 by changing a rotational speed of either or both of the ring gear part 110 and the sun gear part 130. The change of the output rotational velocity of the carrier part 120 may include acceleration and deceleration of the rotational speed, change of a rotational direction, or the like.

Referring to FIG. 7, the control unit 100 may receive a second power command P2 (S430).

The control unit 100 may determine whether the second power command P2 is appropriate (S440). For example, when the first command torque τ1 is identical to a second command torque τ2 and a first rotational velocity Vo1 is different from a second rotational velocity Vo2, when the first and second torques τ1 and τ2 are different from each other and the first and second rotational velocities Vo1 and Vo2 are identical to each other, or when the first and second command torques τ1 and τ2 are different from each other and the first and second rotational velocities Vo1 and Vo2 are different from each other, the control unit 100 may determine that the second power command P2 is appropriate. If not, the control unit 100 may process the second command power P2 as an error (S460).

When the second power command P2 is appropriate, the control unit 100 may reset the rotational speed Vi1 of the ring gear part 110 and the rotational speed Vi2 of the sun gear part 130 such that the output power corresponds to the second power command P2 (S450).

The control unit 100 may rapidly accelerate (including rapid deceleration) the rotational speed of the carrier part 120 by abruptly stopping the rotation of one of the ring gear part 110 and the sun gear part 130. The rotation rapid acceleration time of the carrier part 120 may correspond to abrupt stop of rotation, whereby the rotation of the output gear part can be rapidly accelerated in accordance with braking time. The control unit 100 may adjust the rotational velocities of the first and second input gear parts (the ring gear part 110 and the sun gear part 130) so that the output gear part (the carrier part 120) rotates clockwise or counterclockwise at a specific rotational speed or is in a stationary state. In this case, the rotational speeds of the first and second input gear parts are constant and preferably greater than zero. The rotation directions of the first and second input gear parts are preferably identical to the rotational directions at the time of initial driving. That is, when the output power of the output gear part is adjusted, the rotation direction of each of the first and second driving units must be consistent from the beginning.

The rotational speeds of the first and second input gear parts may be determined according to the number of teeth of the ring gear 112 and the sun gear 132 and relative velocities of each other. For example, in order to bring the output gear part into a stationary state, the rotational velocities of the first and second input gear parts may rotate in opposite directions to each other and maintain angular speeds of each other to be inversely proportional to the number of each other's teeth.

When the output gear part in a stationary state is to be brought to a specific rotational speed in a specific direction, the control unit 100 may accelerate or decelerate the first input gear part, accelerate or decelerate the second input gear part, or accelerate one of the first and second input gear parts and decelerate the other input gear part. If necessary, both the first and second input gear parts may be accelerated or decelerated. When all the first and second input gear parts are accelerated or decelerated, it is preferable to change an acceleration rate. In the case of deceleration, the first and second input gear parts may be decelerated using a braking unit (not shown). The braking unit may be implemented by various braking devices.

As an example of rapid acceleration, the control unit 100 may control the rotational velocity of the carrier part 120 to be zero by rotating the ring gear part 110 and the sun gear part 130 at a specific rotational velocity according to a reduction ratio of each gear part 110, 120, and 130. Thereafter, when any one of the ring gear part 110 and the sun gear part 130 is suddenly braked, the rotational velocity of the carrier part 120 is rapidly accelerated in accordance with the reduction ratio of each gear part in proportion to the rapid braking time.

In the case of a prime mover device, such as an actuator, a strong load is initially imposed when the prime mover device transits from a stationary state to a motion state. However, in the case of the present embodiment, the first and second input gear parts transit from a motion state to another motion state, and thus the load burden at the initial driving may be significantly reduced.

Based on the principle described above, when the output gear part is switched from forward rotation to reverse rotation, for example, from clockwise to counterclockwise, smooth and natural velocity change may be achieved by changing the amounts of rotation of the first and second input gear parts.

According to the control described above, for controlling the rotational velocity of the output gear part, the first and second input gear parts, which are the input part, do not need to change from a stationary state to a motion state, or from forward rotation to reverse rotation. Also, both the first and second input gear parts, which are the input part, may be decelerated for rapid acceleration of the output gear part, and at this time, there is no influence of resistance generated at the time of acceleration of the driving device (the first and second driving units 152 and 162). Accordingly, the output gear part may have a high torque.

In order to further increase moments of inertia of the first and second input driving units 152 and 162, at least one of the first and second input gear parts may further include a flywheel 154 or 164. It is preferable that any one of the first and second input gear parts includes the flywheel and the brake mentioned above brakes the rotation of the other input gear part that does not include the flywheel.

FIG. 5 is a diagram illustrating another embodiment of the rotating device. Referring to FIG. 5, the rotating device according to another embodiment of the present invention may include a plurality of gear part 210, 220, and 230 and a plurality of drive feeding units 250, 260, and 270. A speed reduction device according to the present embodiment may be a differential gear device.

The plurality of drive feeding units 250, 260, and 270 may correspond to the first to third drive feeding unit D1 to D3 of FIG. 1, and two of the drive feeding units 250, 260, and 270 may correspond to the first and second driving units 152 and 162 shown in FIGS. 2 to 4. Hence, a detailed description will be omitted.

The plurality of gear parts may include a differential gear part 220, a first side gear part 210, and a second gear part 230. The plurality of gear parts 210, 220, and 230 may correspond to the first to third gear parts G1 to G3 shown in FIG. 1. That is, the first gear part G1 may correspond to the first side gear part 210, the second gear part G2 may correspond to the differential gear part 220, and the third gear part G3 may correspond to the second side gear part 230.

The differential gear part 220 may include a driving gear 222 and a differential case 221. The differential case 221 may be rotatable and accommodate the driving gear 222. The driving gear 222 may correspond to the first gear g1 of FIG. 1. A rotation shaft that may correspond to the first rotation shaft a1 of FIG. 1 is not illustrated and may be variously implemented. The differential gear part 220 may further include a ring gear 224 that rotates integrally with the differential case 221.

The first side gear part 210 may include a first driven gear 212 and a first driving gear shaft 215, the second side gear part 230 may include a second driven gear 232 and a second driven gear shaft 235, and the first and second driven gears 212 and 232 and the first and second driven gear shafts 215 and 235 may correspond to the first and third gears g1 and g3 and the first and third rotation shafts a1 and a3 of FIG. 1, respectively.

The first and second driven gears 215 and 235 may be engaged with the driving gear 222 in a bevel gear manner. The first and second driven gears 215 and 235 may be installed in the differential case 221 and respectively connected to the first and third driven gear shafts 215 and 235.

The driving gear 222 may include a planetary pinion that rotates on a pinion shaft fixed to the differential case 221. The first and second driven gears 215 and 235 may be engaged with the driving gear 222, i.e., the planetary pinion.

FIG. 6 is a diagram illustrating still another embodiment of the rotating device. Referring to FIG. 6, the rotating device according to still another embodiment of the present invention may include a plurality of gear parts 310, 320, and 330. A plurality of drive feeding units are omitted from the drawing. A speed reduction device according to the present embodiment may be a harmonic drive device. Rotation shafts connected to the respective gear parts 310, 320, and 330 are not illustrated, but in view of the harmonic drive device, those of ordinary skill in the art to which the present invention pertains should be easily connect the rotation shafts.

The first to third gear parts 310, 320, and 330 may correspond to the first to third gear parts G1 to G3 of FIG. 1.

The first gear part 310 may be provided with an elliptical wave cam 310. The wave cam 310 is also known as a wave generator.

The second gear part 320 may include a flex spline 320 which is mounted on an outside of the wave cam 310, has a plurality of teeth on an outer circumferential surface thereof, and is elastically deformed by the wave cam 310. The second gear part 320 may further include a plurality of ball bearings (not shown) that supports between the wave cam 310 and the flex spline 320.

The third gear part 330 may be provided with a circular spline 330 that accommodates the flex spline 320 and has a tooth shape formed in an interior thereof to which the flex spline 320 is engaged. Preferably, the circular spline 330 has more teeth than the tooth shape of the flex spline 320.

The present invention may be implemented in hardware or in software. Also, the present invention may be implemented as computer-readable code stored in a computer-readable storage medium. That is, the present invention may be implemented in the form of a recording medium including computer executable instructions. A computer-readable medium may be any usable medium that can be accessed by a computer and may include all volatile and nonvolatile media and detachable and non-detachable media. Also, the computer-readable medium may include all computer storage media and communication media. The computer storage medium includes all volatile and nonvolatile media and detachable and non-detachable media implemented by a certain method or technology for storing information such as computer-readable instructions, data structures, program modules, or other data. The communication medium typically includes computer-readable instructions, data structures, program modules, other data of a modulated data signal such as a carrier wave, or other transmission mechanisms, and includes information transmission media. Also, functional programs, codes, and code segments for accomplishing the present invention can be easily construed by programmers skilled in the art to which the present invention pertains.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A rotating device capable of instant acceleration, comprising:
a first gear part including a first gear;
a second gear part including a second gear that is connected to the first gear to rotate relative to the first gear;
a third gear part including a third gear that is connected to the second gear to rotate relative to the second gear; and
first and second driving units for respectively providing a rotational driving force to first and second input gear parts, which are two gear parts of the first to third gear parts, to determine an output power of an output gear part that is a remaining gear part,
wherein at least one of the first and second driving units changes at least one of an output rotational velocity and an output torque, which are the output power, by changing a rotational speed of at least one of the first and second input gear parts,
a rotation direction of the first input gear part before and after the change of the output power is identical to an initial rotation direction of the first input gear part, and
a rotation direction of the second input gear part before and after the change of the output power is identical to an initial rotation direction of the second input gear part.

2. The rotating device of claim 1, wherein when at least one of the output rotational velocity and the output torque is not zero, the rotational speeds of the first and second input gear parts exceed zero.

3. The rotating device of claim 1, wherein the first and second driving units are driven such that the output rotational velocity is zero and the output torque exceeds zero.

4. The rotating device of claim 1, wherein the change of the output power is any one of cases, including where the output rotational velocity is constant and the output torque is changed, where the output rotational velocity is changed and the output torque is constant, and where the output rotational velocity and the output torque are all changed.

5. The rotating device of claim 1, wherein the first and second driving units are driven such that the output rotational velocity is changed from a first direction to a second direction.

6. The rotating device of claim 1, wherein at least one of the first and second driving units abruptly stops at least one of the first and second input gear parts to rapidly change a rotational velocity of the output gear part in response to the abrupt stop.

7. The rotating device of claim 1, wherein at least one of the first and second input gear parts further includes a flywheel that maintains a rotational inertia.

8. The rotating device of claim 1, wherein any one of the two gear parts has a greater rotational inertia than the other gear part and a rotational velocity of the remaining gear part is rapidly changed in response to the abrupt stop of the rotation by abruptly stopping rotation of the gear part of the two gear parts that has a smaller rotational inertia.

9. The rotating device of claim 1, further comprising:
a planetary gear train including a planetary gear part that is connected to a ring gear, a sun gear, and a carrier, which are arranged on the same shaft, and connects the ring gear and the sun gear,
wherein the first gear part includes the ring gear,
the second gear part includes the carrier, and
the third gear part includes the sun gear.

10. The rotating device of claim 1, wherein the second gear part includes a differential case which is rotatable and accommodates a driving gear and the first and third gear parts include first and second driven gears, respectively, that are engaged to the driving gear in a bevel gear manner.

11. The rotating device of claim 1, wherein the first gear part is provided with an elliptical wave cam,
the second gear part is provided with a flex spine that is mounted on an outside of the wave cam, has a plurality of teeth on an outer circumferential surface thereof, and is elastically deformed by the wave cam, and
the third gear part is provided with a circular spline that accommodates the flex spline and has a tooth shape formed in an interior thereof to which the flex spline is engaged.

12. A method of controlling a rotating device capable of instant acceleration which includes a first gear part including a first gear, a second gear part including a second gear that is connected to the first gear to rotate relative to the first gear, a third gear part including a third gear that is connected to the second gear to rotate relative to the second gear, and first and second driving units for respectively providing a rotational driving force to first and second input gear parts, which are two gear parts of the first to third gear parts, to determine an output power of an output gear part that is a remaining gear part, the method comprising:
changing, by at least one of the first and second driving units, at least one of an output rotational velocity and an output torque, which are the output power, by changing a rotational speed of at least one of the first and second input gear parts,
wherein a rotation direction of the first input gear part before and after the change of the output power is identical to an initial rotation direction of the first input gear part and
a rotation direction of the second input gear part before and after the change of the output power is identical to an initial rotation direction of the second input gear part.
